(19) United States
(12) Patent Application Publication
(10) Pub. No.: US 2026/0225701 A1
(43) Pub. Date: Aug. 6, 2026

(54) OUTBOARD MOTOR

(71) Applicant: YAMAHA HATSUDOKI KABUSHIKI KAISHA, Iwata-shi (JP)

(72) Inventor: Yasuyuki MYOKEI, Shizuoka (JP)

(21) Appl. No.: 19/450,033

(22) Filed: Jan. 15, 2026

(30) Foreign Application Priority Data
Feb. 3, 2025 (JP) 2025-016060

(51) Int. Cl. B63H 20/24; B63H 20/10; F02B 61/04

(52) U.S. Cl. CPC B63H 20/245; B63H 20/10; F02B 61/045

(57) ABSTRACT

An outboard motor includes a cowl including an exhaust port, a hydrogen engine inside the cowl, a drive shaft connected to the hydrogen engine and drivable by the hydrogen engine, a propeller connected to the drive shaft, a fan inside the cowl to discharge gases inside the cowl to outside of the cowl through the exhaust port, a hydrogen sensor inside the cowl to detect a hydrogen concentration inside the cowl, and a controller configured or programmed to drive the fan when the hydrogen concentration detected by the hydrogen sensor becomes equal to or greater than a predetermined first threshold while the hydrogen engine is stopped.

### CROSS-REFERENCE TO RELATED APPLICATIONS

The present application claims priority to Japanese Patent Application No. 2025-016060 filed on Feb. 3, 2025, the entire contents of which are hereby incorporated herein by reference.

### BACKGROUND OF THE INVENTION

### 1. Field of the Invention

The present invention relates to outboard motors.

### 2. Description of the Related Art

Outboard motors are known as propulsion devices mounted on vessels (see, for example, Japanese Patent Application Publication No. 2020-101095). An outboard motor includes a propeller, an engine that drives the propeller, and a cowl that houses the engine.

In recent years, hydrogen-fueled engines (hereinafter also referred to as hydrogen engines) have attracted attention for purposes such as reducing CO₂ emissions. Therefore, one may consider using a hydrogen engine as the engine for an outboard motor.

### SUMMARY OF THE INVENTION

Example embodiments of the present invention provide outboard motors including hydrogen engines.

An outboard motor according to an example embodiment of the present invention includes a cowl including an exhaust port, a hydrogen engine inside the cowl, a drive shaft connected to the engine and drivable by the engine, a propeller connected to the drive shaft, a fan inside the cowl and configured to discharge gases inside the cowl to outside of the cowl through the exhaust port, a hydrogen sensor inside the cowl and configured to detect a hydrogen concentration inside the cowl, and a controller configured or programmed to drive the fan when the hydrogen concentration detected by the hydrogen sensor becomes equal to or greater than a first threshold while the engine is stopped.

With the outboard motor described above, the fan is driven when the hydrogen concentration inside the cowl becomes equal to or greater than the first threshold while the engine is stopped. Thus, hydrogen inside the cowl is discharged to the outside of the cowl through the exhaust port. Therefore, it is possible to reduce or prevent a high hydrogen concentration inside the cowl while the engine is stopped.

The engine may include a crank shaft, and the fan may be connected to the crank shaft and rotatable by a driving force of the crank shaft. The outboard motor may include a starter motor connected to the crank shaft and configured to rotate the crank shaft. The controller may be configured or programmed to drive the fan by driving the starter motor.

With this configuration, since the fan is connected to the crank shaft, the fan is driven while the engine is operating. While the engine is operating, it is possible to discharge hydrogen from the inside to the outside of the cowl, and since an airflow is generated inside the cowl, it is possible to cool the engine by this airflow. On the other hand, while the engine is stopped, the fan is able to be driven by driving the starter motor. With this configuration, the fan, used to cool the engine while the engine is operating is utilized as a fan to forcibly discharge hydrogen from the cowl while the engine is stopped.

The fan may be an electric fan. Thus, it is possible to easily control the fan.

The hydrogen sensor may be located above the engine when the drive shaft extends in a vertical direction.

Being a relatively light gas, hydrogen tends to accumulate in the upper portion of the inside of the cowl. With this configuration, the hydrogen sensor is located at a relatively high position. Therefore, it is possible to accurately detect the hydrogen concentration inside the cowl.

The outboard motor may include an outboard motor body including the cowl, the engine, the drive shaft, the propeller, the fan, and the hydrogen sensor, and a tilt shaft that supports the outboard motor body so that the outboard motor body is rotatable in a front-rear direction. The hydrogen sensor may be located rearward of a middle position between a front end and a rear end of the cowl when the drive shaft extends in the vertical direction.

When the vessel is docked, for example, the outboard motor body may be tilted forward. In this case, a portion of the cowl that is located rearward of the middle position moves upward as the outboard motor rotates. With this configuration, when the outboard motor is tilted forward, the position of the hydrogen sensor is kept at a relatively high position inside the cowl, Therefore, even when the outboard motor is tilted forward, it is possible to accurately detect the hydrogen concentration inside the cowl.

The exhaust port may be located above the engine when the drive shaft extends in a vertical direction.

Being a relatively light gas, hydrogen tends to accumulate in the upper portion of the inside of the cowl. With this configuration, it is possible to efficiently discharge hydrogen inside the cowl through the exhaust port.

The engine may include a crankcase supporting the crank shaft, a cylinder body connected to the crankcase, a cylinder head connected to the cylinder body, and a cylinder head cover connected to the cylinder head. The outboard motor may include a gas passage including an inlet connected to the crankcase, the cylinder body, the cylinder head, or the cylinder head cover, and an outlet that opens toward an inside of the cowl. The outboard motor may include an electric valve in the gas passage.

With hydrogen engines, hydrogen may accumulate inside the crankcase, the cylinder body, the cylinder head, or the cylinder head cover (hereinafter referred to as the inside of the engine). With the configuration described above, by opening the electric valve, it is possible to discharge hydrogen inside the engine into the inside of the cowl through the gas passage. The hydrogen inside the cowl is forcibly discharged by the fan as described above. Therefore, with the configuration described above, hydrogen inside the engine can be forcibly discharged to the outside of the cowl.

The outboard motor may include a propeller shaft connected to the propeller, and a clutch connected to the drive shaft and the propeller shaft. The controller may be electrically connected to the electric valve and configured or programmed to execute a control to close the electric valve when the clutch is engaged and the engine is operating, and to open the electric valve when the clutch is disengaged or the engine is stopped.

Thus, it is possible to discharge hydrogen inside the engine to the outside of the engine while the engine is stopped or idling.

The outboard motor may include a propeller shaft connected to the propeller. The controller may be electrically connected to the electric valve and configured or programmed to execute a control to close the electric valve when a rotational speed of the propeller shaft is equal to or greater than a predetermined first speed, and to open the electric valve when the rotational speed of the propeller shaft is less than the first speed.

Thus, it is possible to discharge hydrogen inside the engine to the outside of the engine by opening the electric valve when the engine is operating at a low speed.

The outboard motor may include a starter motor connected to the crank shaft to rotate the crank shaft. The controller may be configured or programmed to open the electric valve and drive the starter motor for a predetermined period of time before the engine is started or after the engine is stopped.

Thus, it is possible to discharge hydrogen inside the engine to the outside of the engine by cranking before the engine is started or after the engine is stopped.

The controller may be configured or programmed to prevent starting the engine when the hydrogen concentration detected by the hydrogen sensor is equal to or greater than a predetermined second threshold.

Thus, it is possible to prevent the engine from being started when the hydrogen concentration inside the cowl is relatively high.

According to example embodiments of the present invention, it is possible to provide outboard motors including hydrogen engines with improved performance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view of a vessel according to an example embodiment of the present invention.

FIG. 2 is a side view of an outboard motor according to an example embodiment of the present invention.

FIG. 3 is a perspective view of an upper portion of the cowl of the outboard motor.

FIG. 4 is a cross-sectional view of the cowl taken along line IV-IV of FIG. 3.

FIG. 5 is a perspective view of the cowl with a first case removed.

FIG. 6 is a perspective view of an exhaust duct with an upper duct case removed from a lower duct case.

FIG. 7 is a front view schematically showing an upper portion of the engine in the outboard motor.

FIG. 8 is a side view showing the outboard motor body in an untilted position and in a tilted position.

FIG. 9 is a perspective view of the engine.

FIG. 10 is a plan view of the engine.

FIG. 11 is a block diagram of a control system of the outboard motor.

FIG. 12 is a perspective view of a fan according to another example embodiment of the present invention.

### DETAILED DESCRIPTION OF THE EXAMPLE EMBODIMENTS

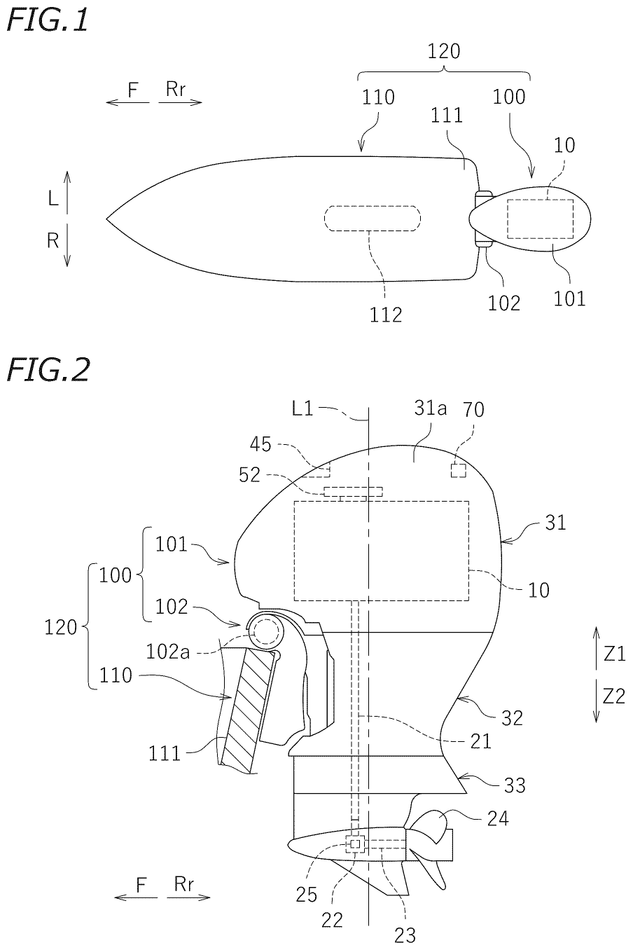

Example embodiments of the outboard motor will now be described with reference to the drawings. FIG. 1 is a schematic plan view of a vessel 120 including an outboard motor 100. The vessel 120 includes a hull 110 and the outboard motor 100. The hull 110 includes a hydrogen tank 112 filled with hydrogen. The hydrogen tank 112 is housed inside the hull 110. The outboard motor 100 is mounted at a rear portion of the hull 110.

FIG. 2 is a side view of the outboard motor 100. As shown in FIG. 2, the outboard motor 100 includes an outboard motor body 101 and a bracket 102. The outboard motor body 101 is mounted at a stern 111 of the hull 110 via the bracket 102. The bracket 102 includes a tilt shaft 102a extending in the left-right direction. The outboard motor body 101 is rotatably supported on the tilt shaft 102a. The tilt shaft 102a supports the outboard motor body 101 so that the outboard motor body 101 can rotate in the front-rear direction. By rotating the outboard motor body 101 about the tilt shaft 102a, it is possible to change the tilt attitude of the outboard motor body 101 relative to the hull 110. The outboard motor body 101 can be tilted relative to the hull 110.

FIG. 2 shows the outboard motor 100 when a drive shaft 21 to be described below extends in the vertical direction. That is, FIG. 2 shows the state where the outboard motor body 101 is not tilted. When the outboard motor body 101 rotates forward about the tilt shaft 102a (rotates counterclockwise in FIG. 2), the outboard motor body 101 tilts forward. In this case, the drive shaft 21 extends rearward from the engine 10 (the term rearward as used herein also includes rearward and downward or rearward and upward). Conversely, when the outboard motor body 101 rotates rearward about the tilt shaft 102a (rotates clockwise in FIG. 2), the outboard motor body 101 tilts rearward. In this case, the drive shaft 21 extends forward and downward from the engine 10.

Note that the designations F, Rr, L, R, Z1, and Z2 in the drawings indicate the forward direction of the outboard motor body 101 in the front-rear direction, the rearward direction of the outboard motor body 101 in the front-rear direction, the leftward direction of the outboard motor body 101 in the left-right direction, the rightward direction of the outboard motor body 101 in the left-right direction, the upward direction of the outboard motor body 101 in the up-down direction, and the downward direction of the outboard motor body 101 in the up-down direction, respectively.

The outboard motor body 101 includes the engine 10, e.g., an internal combustion engine, the drive shaft 21, a gear unit 22, a propeller shaft 23, and a propeller 24. The outboard motor body 101 also includes a cowl 31, an upper case 32, and a lower case 33.

The engine 10 is a hydrogen engine, i.e., an engine that runs on hydrogen. The engine 10 is housed in the cowl 31. That is, the engine 10 is located inside the cowl 31. Details of the engine 10 will be described below.

The drive shaft 21 is connected to the engine 10. The drive shaft 21 rotates by being driven by the engine 10. The drive shaft 21 extends downward from the engine 10. The drive shaft 21 is housed in the cowl 31, the upper case 32, and the lower case 33.

The gear unit 22 is connected to the lower end portion of the drive shaft 21 and the front end portion of the propeller shaft 23. The driving force of the drive shaft 21 is transmitted to the propeller shaft 23 via the gear unit 22. Although not shown, the gear unit 22 includes a plurality of gears. The drive shaft 21 and the propeller shaft 23 are connected via the gear unit 22. The gear unit 22 also includes a clutch 25. When the clutch 25 is engaged, the driving force of the drive shaft 21 is transmitted to the propeller shaft 23 via the clutch 25. When the clutch 25 is disengaged, the driving force of the drive shaft 21 is not transmitted to the propeller shaft 23.

The propeller shaft 23 extends rearward from the gear unit 22. The propeller 24 is connected to the rear end portion of the propeller shaft 23. The propeller 24 rotates as the propeller shaft 23 rotates. The propeller shaft 23 and the propeller 24 are located below the engine 10. The driving force of the engine 10 is transmitted to the propeller 24 via the drive shaft 21, the gear unit 22, and the propeller shaft 23. The propeller 24 rotates due to the driving force of the engine 10. By rotating underwater, the propeller 24 generates a propulsive force to propel the vessel 120.

The upper case 32 is located below the cowl 31, and the lower case 33 is located below the upper case 32. The cowl 31, the upper case 32, and the lower case 33 together define the housing of the outboard motor body 101. There is no particular limitation on the materials of the cowl 31, the upper case 32, and the lower case 33, but in the present example embodiment, the cowl 31 is made of a resin, and the upper case 32 and the lower case 33 are made of a metal such as aluminum. The lower case 33 houses the lower portion of the drive shaft 21, the gear unit 22, and the propeller shaft 23. The propeller 24 is located rearward of the lower case 33.

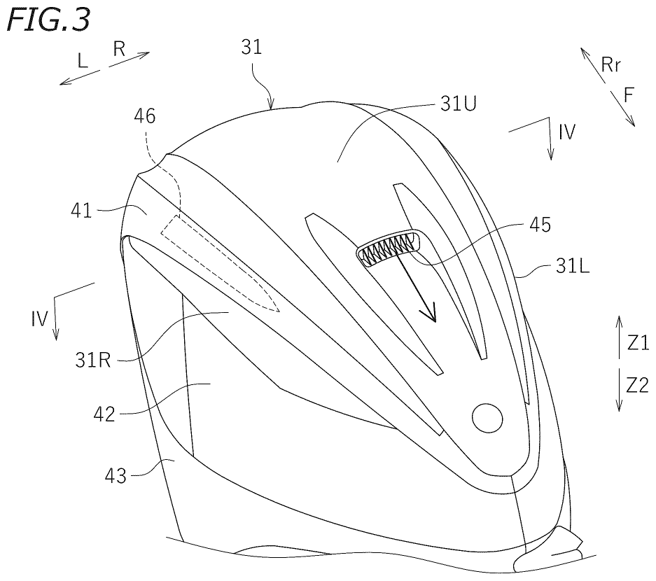

FIG. 3 is a perspective view of an upper portion of the cowl 31. The cowl 31 includes a first case 41, a second case 42, and a third case 43. The first case 41 is assembled to the second case 42 and located above the second case 42. The second case 42 is assembled to the third case 43 and located above the third case 43.

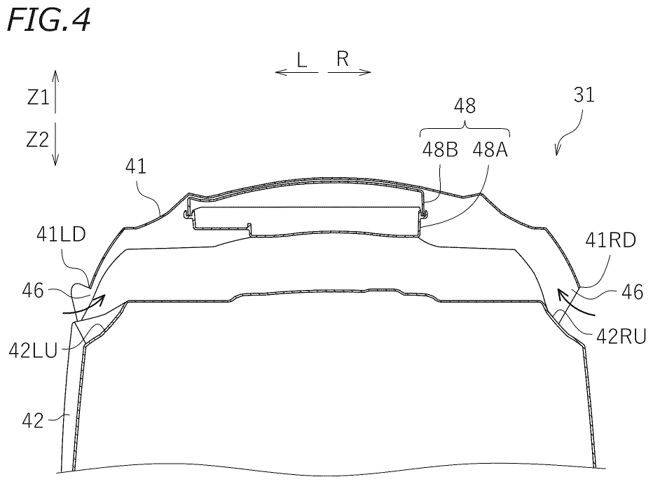

An intake port 46 connects the inside and the outside of the cowl 31. The intake port 46 is located in a left side portion 31L and a right side portion 31R of the cowl 31. FIG. 4 is a cross-sectional view of the cowl 31 taken along line IV-IV of FIG. 3. As shown in FIG. 4, a left upper portion 42LU of the second case 42 is inclined rightward. The left upper portion 42LU of the second case 42 extends upward and rightward. A lower edge portion 41LD on the left side of the first case 41 is spaced apart leftward relative to the left upper portion 42LU of the second case 42. The gap between the lower edge portion 41LD on the left side of the first case 41 and the left upper portion 42LU of the second case 42 defines the left-side intake port 46. Similarly, a right upper portion 42RU of the second case 42 is inclined leftward. The right upper portion 42RU of the second case 42 extends upward and leftward. A lower edge portion 41RD on the right side of the first case 41 is spaced apart rightward relative to the right upper portion 42RU of the second case 42. The gap between the lower edge portion 41RD on the right side of the first case 41 and the right upper portion 42RU of the second case 42 defines the right-side intake port 46. Note, however, that the configuration of the intake port 46 described herein is merely an example. The position, orientation, shape, dimension, etc., of the intake port 46 may be changed as appropriate.

As shown in FIG. 3, an exhaust port 45 is provided in the cowl 31 and connects between the inside and the outside of the cowl 31. Here, the exhaust port 45 is located in an upper portion 31U of the cowl 31. The exhaust port 45 is located in the first case 41 and is provided at a relatively high position. The exhaust port 45 opens forward. As viewed from the front, the exhaust port 45 has a horizontally elongated rectangular shape. Note, however, that the configuration of the exhaust port 45 described herein is merely an example. There is no particular limitation on the position, orientation, shape, dimension, etc., of the exhaust port 45.

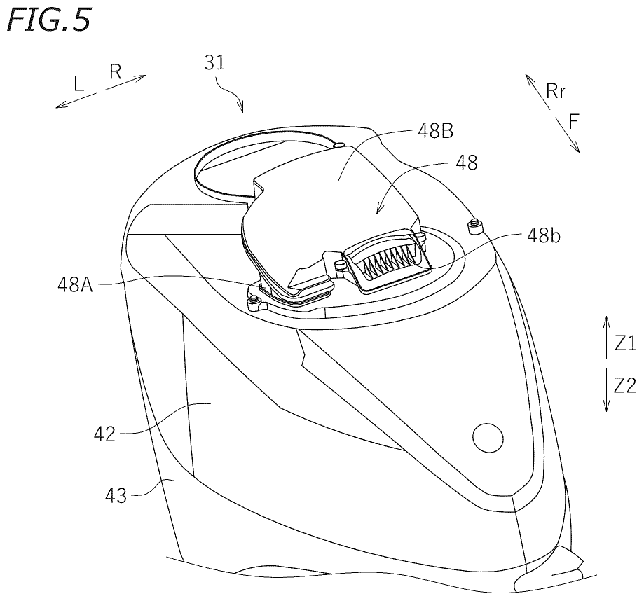

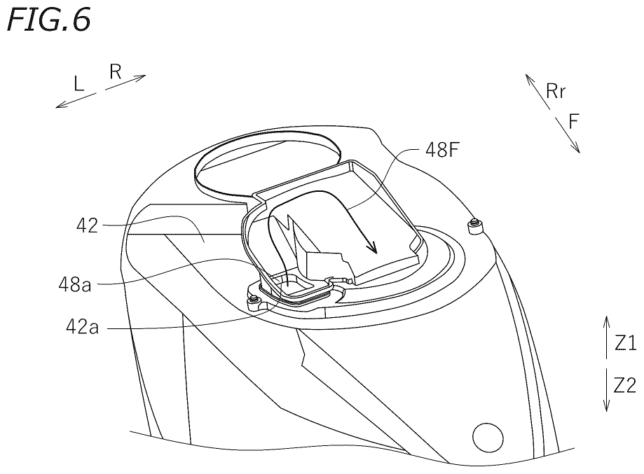

FIG. 5 is a perspective view of the cowl 31 with the first case 41 removed. As shown in FIG. 5, the cowl 31 is provided with an exhaust duct 48. The exhaust duct 48 is located between the first case 41 and the second case 42. The exhaust duct 48 includes a lower duct case 48A fixed to the second case 42, and an upper duct case 48B fixed to the lower duct case 48A. FIG. 6 is a perspective view of the exhaust duct 48 with the upper duct case 48B removed from the lower duct case 48A. As shown in FIG. 6, the second case 42 includes an opening 42a extending therethrough in the up-down direction. A duct inlet 48a, which opens downward, is provided in the lower duct case 48A. The duct inlet 48a connects to the opening 42a of the second case 42. As shown in FIG. 5, a duct outlet 48b, which opens forward, is provided in the upper duct case 48B. The duct outlet 48b connects to the exhaust port 45 (see FIG. 3) in the first case 41. The upper duct case 48B and the lower duct case 48A partition the flow path (see arrow 48F in FIG. 6) extending from the duct inlet 48a to the duct outlet 48b.

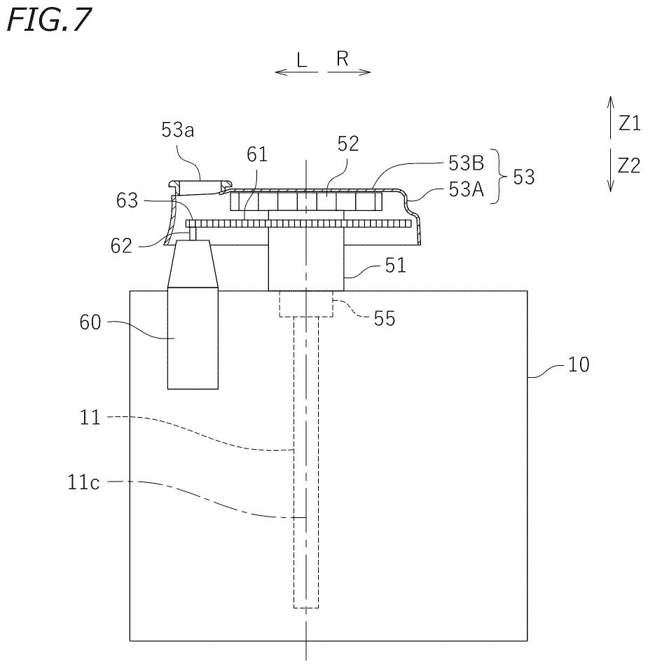

FIG. 7 is a front view schematically showing an upper portion of the engine 10. As shown in FIG. 7, the outboard motor body 101 includes a rotation shaft 51 connected to a crank shaft 11 of the engine 10, and a fan 52 connected to the rotation shaft 51. Note that the reference sign 11c indicates the central axis of the crank shaft 11. The rotation shaft 51 is connected to the crank shaft 11 via a reduction gear 55. While there is no particular limitation on the configuration of the fan 52, the fan 52 according to the present example embodiment is implemented by a centrifugal blower that draws in air along the axial direction and discharges air in the direction perpendicular to the axial direction. Here, the fan 52 is a cylindrical multi-blade fan including a plurality of blades. A fan casing 53 is provided around the fan 52. The fan casing 53 surrounds the fan 52. The fan casing 53 includes a cylindrical portion 53A surrounding the fan 52, and an upper plate portion 53B covering the upper side of the cylindrical portion 53A. The upper plate portion 53B includes an opening 53a extending therethrough in the up-down direction. The opening 53a connects to the opening 42a of the second case 42 (see FIG. 6).

When the rotation shaft 51 rotates, the fan 52 rotates. When the fan 52 rotates, air is drawn into the inside of the cowl 31 from the outside through the intake port 46 (see FIG. 3 and FIG. 4). Furthermore, when the fan 52 rotates, air inside the cowl 31 is passed to the duct inlet 48a of the exhaust duct 48 via the opening 53a of the fan casing 53 and the opening 42a of the second case 42. This air flows into the exhaust duct 48 from the duct inlet 48a, circulates inside the exhaust duct 48, and reaches the duct outlet 48b (see arrow 48F in FIG. 6). The air having passed through the duct outlet 48b is discharged outside the cowl 31 through the exhaust port 45 of the cowl 31. In the present example embodiment, the rotation of the fan 52 creates a flow of air that circulates inside the cowl 31. That is, air is drawn in through the intake port 46 in the upper portion of the cowl 31, flows downward inside the cowl 31, and then rises toward the exhaust duct 48, to be discharged through the exhaust port 45 after passing through the exhaust duct 48.

As shown in FIG. 7, the outboard motor body 101 includes a starter motor 60. A gear 63 is fixed to an output shaft 62 of the starter motor 60. The gear 63 meshes with a gear 61 fixed to the rotation shaft 51. The starter motor 60 is connected to the rotation shaft 51 via the gear 63 and the gear 61. As described above, the rotation shaft 51 is connected to the crank shaft 11 of the engine 10. Therefore, the starter motor 60 is connected to the crank shaft 11 via the rotation shaft 51. When the starter motor 60 is driven, the driving force of the starter motor 60 is transmitted to the crank shaft 11 via the rotation shaft 51. It is possible to start the engine 10 by driving the starter motor 60 to rotate the crank shaft 11 and injecting fuel by the rotation of the crank shaft 11. On the other hand, it is possible to rotate the fan 52 while keeping the engine 10 stopped by driving the starter motor 60 while preventing fuel injection.

As shown in FIG. 2, the outboard motor body 101 includes a hydrogen sensor 70. The hydrogen sensor 70 is located inside the cowl 31. The position at which the hydrogen sensor 70 is located can be selected appropriately. The hydrogen sensor 70 may be located inside the first case 41 of the cowl 31 or inside the second case 42. The hydrogen sensor 70 detects the hydrogen concentration inside the cowl 31. In the present example embodiment, the hydrogen sensor 70 is located above the engine 10 when the outboard motor body 101 is not tilted. In other words, the hydrogen sensor 70 is located above the engine 10 when the drive shaft 21 extends in the vertical direction.

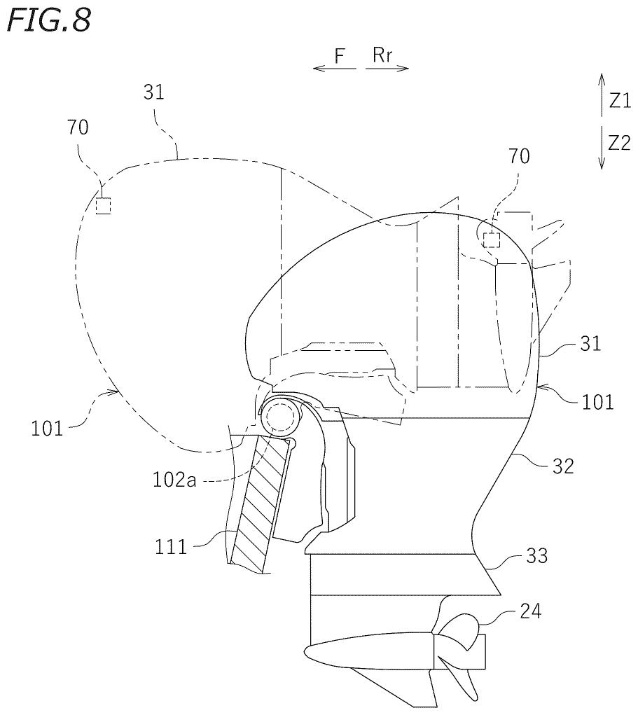

In FIG. 2, the straight line L1 is a vertical line extending through the middle position between the front end and the rear end of the cowl 31 when the drive shaft 21 extends in the vertical direction. In the present example embodiment, the hydrogen sensor 70 is located rearward of the straight line L1. Hereinafter, unless otherwise specified, the middle position between the front end and the rear end of the cowl 31 when the drive shaft 21 extends in the vertical direction will be referred to as the middle position of the cowl 31 in the front-rear direction. The hydrogen sensor 70 is located rearward of the middle position of the cowl 31 in the front-rear direction. Therefore, as shown in FIG. 8, even when the outboard motor body 101 is tilted forward, the position of the hydrogen sensor 70 is kept at a relatively high position within the cowl 31.

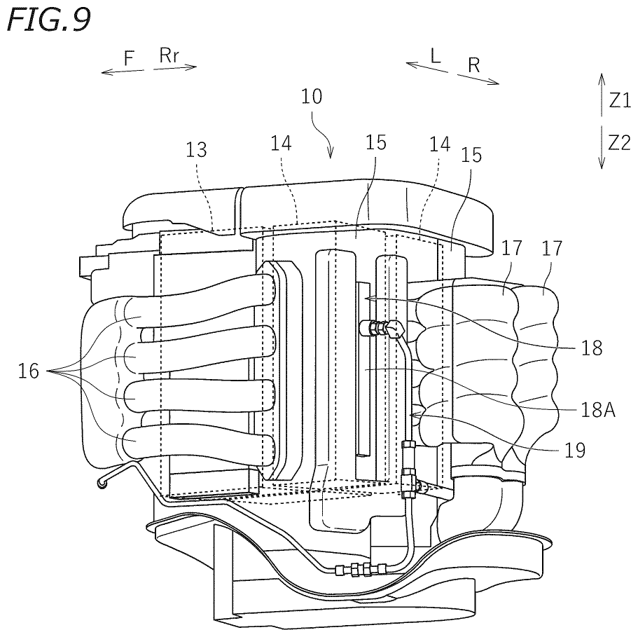

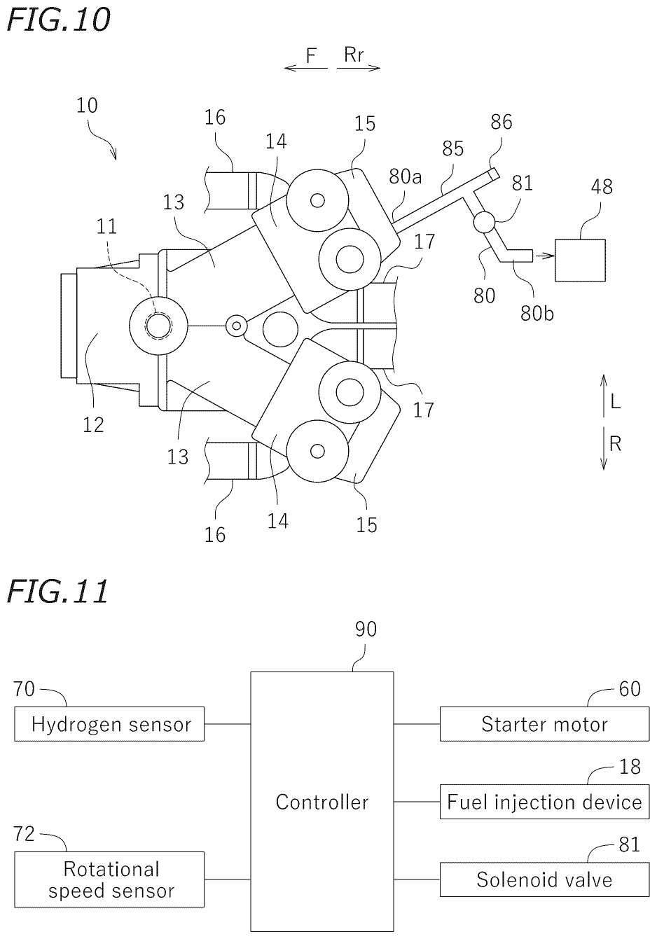

FIG. 9 is a perspective view of the engine 10. FIG. 10 is a plan view of the engine 10. The engine 10 according to the present example embodiment is a so-called V-type 8-cylinder engine. The engine 10 includes two sets of four cylinders arranged in the up-down direction, one on the left side and the other on the right side. As shown in FIG. 10, the engine 10 includes a crankcase 12 supporting the crank shaft 11, a cylinder body 13 connected to the crankcase 12, a cylinder head 14 connected to the cylinder body 13, and a cylinder head cover 15 connected to the cylinder head 14. An intake manifold 16 and an exhaust manifold 17 are connected to the cylinder head 14.

As shown in FIG. 9, the engine 10 includes a fuel injection device 18. The fuel injection device 18 is mounted on the cylinder head 14. The fuel injection device 18 includes a delivery pipe 18A and an injector (not shown) connected to the delivery pipe 18A. The injector is configured to inject hydrogen as fuel into the inside of the cylinder body 13. A hydrogen supply pipe (hereinafter referred to as a hydrogen pipe) 19 is connected to the delivery pipe 18A. The delivery pipe 18A and the injector are located rearward of the middle position of the cowl 31 in the front-rear direction. A large portion of the hydrogen pipe 19 is located rearward of the middle position of the cowl 31 in the front-rear direction. As described above, the hydrogen sensor 70 is located above the engine 10 and rearward of the middle position of the cowl 31 in the front-rear direction. Therefore, the hydrogen sensor 70 is located above a portion of the engine 10 where the delivery pipe 18A and the injector are located. The hydrogen sensor 70 is located above a portion of the engine 10 where the hydrogen pipe 19 is located.

As schematically shown in FIG. 10, a gas passage 80 is connected to the engine 10 and communicates between the inside and the outside of the engine 10. In the present example embodiment, the gas passage 80 includes an inlet 80a connected to the cylinder head cover 15 and an outlet 80b that opens toward the inside of the cowl 31. The gas passage 80 may be any passage that communicates between the inside and the outside of the engine 10 to allow hydrogen to be discharged from the inside to the outside of the engine 10, and there is no particular limitation on the configuration thereof. The gas passage 80 may be a dedicated passage to discharge hydrogen from the inside of the engine 10, or an existing passage used for other purposes may be used partially. For example, as shown in FIG. 10, a passage 85 to supply engine oil to the inside of the engine 10 may be used partially. Note that an oil filler cap 86 is fitted into the passage 85 to supply the engine oil.

There is no particular limitation on the material of the gas passage 80. A portion or all of the gas passage 80 may be a rigid pipe, or may be a flexible hose. The gas passage 80 may be any passage that communicates between the inside of the engine 10 and the inside of the cowl 31. Here, the inlet 80a of the gas passage 80 is connected to the cylinder head cover 15, but the inlet 80a may be connected to the crankcase 12, the cylinder body 13, or the cylinder head 14. In order to enable speedy discharge of hydrogen from the inside of the engine 10 to the outside of the cowl 31, the outlet 80b of the gas passage 80 is preferably located near the duct inlet 48a of the exhaust duct 48. The inlet 80a of the gas passage 80 may be located outside the exhaust duct 48, but may be located inside the exhaust duct 48. The inlet 80a of the gas passage 80 may be connected to the exhaust duct 48. When the inlet 80a is connected to the exhaust duct 48, hydrogen can be fed directly from the gas passage 80 into the exhaust duct 48. Therefore, hydrogen inside the engine 10 can be quickly discharged to the outside of the cowl 31.

A solenoid valve 81 is provided in the gas passage 80. The solenoid valve 81 is an example of an electric valve that opens and closes in response to an electrical signal. The solenoid valve 81 is configured to open and close the gas passage 80.

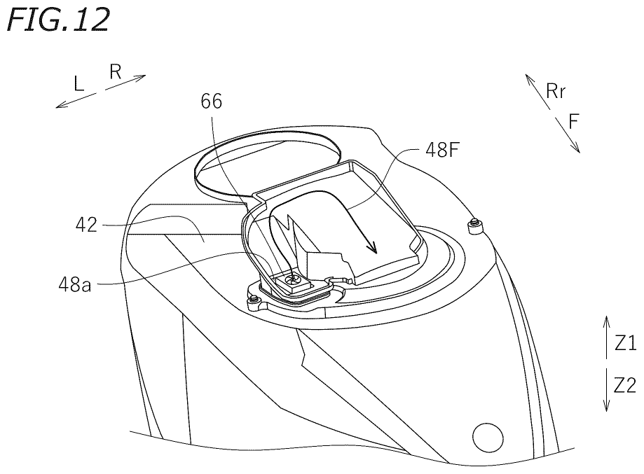

As shown in FIG. 11, the outboard motor 100 includes a controller 90. Although not shown, the controller 90 may include a microcomputer including a CPU, a RAM, a ROM, and a communication interface, or the like. The controller 90 is electrically connected to the hydrogen sensor 70 and receives signals from the hydrogen sensor 70. Information regarding the hydrogen concentration detected by the hydrogen sensor 70 is input to the controller 90. The outboard motor 100 includes a rotational speed sensor 72 that detects the rotational speed of the crank shaft 11 of the engine 10 (hereinafter also referred to as the engine rotational speed). The controller 90 is electrically connected to the rotational speed sensor 72 and receives signals from the rotational speed sensor 72. The controller 90 can determine whether or not the engine 10 is stopped based on the engine rotational speed. The controller 90 is electrically connected to the starter motor 60, the fuel injection device 18 (specifically, the injector of the fuel injection device 18), and the solenoid valve 81. The controller 90 is configured or programmed so that the controller 90 can control the starter motor 60, the fuel injection device 18, and the solenoid valve 81. The controller 90 controls the output of the engine 10 by controlling the fuel injection device 18.

If the hydrogen concentration detected by the hydrogen sensor 70 becomes equal to or greater than a predetermined first threshold while the engine 10 is stopped, the controller 90 executes a control to drive the fan 52. As the fan 52 rotates, hydrogen inside the cowl 31 is discharged, along with air, to the outside of the cowl 31 through the exhaust port 45. Thus, it is possible to reduce or prevent a high hydrogen concentration inside the cowl 31. Note that the first threshold can be set appropriately, for example, at 2%. The controller 90 can rotate the fan 52 while keeping the engine 10 stopped by driving the starter motor 60 while preventing fuel injection by fuel injection device 18. The controller 90 can discharge hydrogen from the inside to the outside of the cowl 31 while keeping the engine 10 stopped. Note that the fan 52 may be driven for a predetermined period of time or until the hydrogen concentration detected by the hydrogen sensor 70 becomes less than or equal to a predetermined threshold.

The controller 90 is configured or programmed to execute a control to prevent starting the engine 10 when the hydrogen concentration detected by the hydrogen sensor 70 is equal to or greater than a predetermined second threshold. That is, the controller 90 prevents starting the engine 10 by not driving the starter motor 60 or not injecting fuel from the fuel injection device 18, even if a vessel crew performs the operation of starting the engine 10, when the hydrogen concentration inside the cowl 31 is high.

As will be described below, the controller 90 is configured or programmed to perform various controls to open and close the solenoid valve 81 (see FIG. 10) of the gas passage 80 according to the operating state of the outboard motor 100.

The controller 90 is configured or programmed to perform a control to close the solenoid valve 81 when the engine 10 is operating normally, and to open the solenoid valve 81 when the engine 10 is stopped or idling. Specifically, the controller 90 closes the solenoid valve 81 when the clutch 25 (see FIG. 2) is engaged and the engine 10 is running. The controller 90 opens the solenoid valve 81 when the clutch 25 is disengaged or the engine 10 is stopped. By executing such controls, it is possible to discharge hydrogen inside the engine 10 to the outside of the engine 10 while the engine is stopped or idling.

The controller 90 may open the solenoid valve 81 even when the engine 10 is operating, if the rotational speed of the propeller shaft 23 is very low. That is, the controller 90 may open the solenoid valve 81 to discharge hydrogen inside the engine 10 to the outside when the outboard motor 100 is operating at a very low speed. Specifically, the controller 90 is configured or programmed to execute a control to close the solenoid valve 81 when the rotational speed of the propeller shaft 23 is equal to or greater than a predetermined first speed, and to open the solenoid valve 81 when the rotational speed of the propeller shaft 23 is less than the first speed. Note that the rotational speed of the propeller shaft 23 can be calculated based on the rotational speed of the crank shaft 11 detected by the rotational speed sensor 72. The controller 90 may indirectly determine the rotational speed of the propeller shaft 23. The outboard motor body 101 may include a sensor that detects the rotational speed of the propeller shaft 23, and the controller 90 may be configured or programmed to directly determine the rotational speed of the propeller shaft 23 by this sensor. Note that, although there is no particular limitation, the outboard motor 100 is operated at a very low speed when the vessel 120 is docked, for example. Whether the vessel 120 is docked can be detected by utilizing GPS, for example. Therefore, the controller 90 may execute a control to open the solenoid valve 81 when the vessel 120 is docked and the outboard motor 100 is operating at a very low speed.

The controller 90 may be configured or programmed to execute a control to open the solenoid valve 81 and drive the starter motor 60 for a predetermined period of time before the engine 10 is started. With this control, it is possible to discharge hydrogen inside the engine 10 to the outside of the engine 10 before the engine 10 is started. The controller 90 may also execute a control to open the solenoid valve 81 and drive the starter motor 60 for a predetermined period of time after the engine 10 is stopped. With this control, it is possible to discharge hydrogen inside the engine 10 to the outside of the engine 10 after the engine 10 is stopped. Note that along with the discharge of hydrogen, water vapor inside the combustion chamber is also discharged to the outside of the engine 10. Therefore, this control can reduce or prevent rusting on the inside of the engine 10.

Next, various effects provided by example embodiments of the present invention will be described.

As described above, the outboard motor 100 according to an example embodiment includes the cowl 31 including the exhaust port 45, the fan 52 configured to discharge gases inside the cowl 31 to the outside of the cowl 31 through the exhaust port 45, the hydrogen sensor 70 to detect a hydrogen concentration inside the cowl 31, and the controller 90 configured or programmed to drive the fan 52 when the hydrogen concentration detected by the hydrogen sensor 70 becomes equal to or greater than the first threshold while the engine 10 is stopped. According to an example embodiment, the fan 52 is driven when the hydrogen concentration inside the cowl 31 becomes high (that is, becomes equal to or greater than the first threshold) while the engine 10 is stopped. Thus, hydrogen inside the cowl 31 is discharged to the outside of the cowl 31 through the exhaust port 45. Thus, according to an example embodiment, it is possible to reduce or prevent a high hydrogen concentration inside the cowl 31 while the engine 10 is stopped.

According to an example embodiment, since the fan 52 is connected to the crank shaft 11 of the engine 10, the fan 52 is driven while the engine 10 is operating. Since airflow is generated inside the cowl 31 while the engine 10 is operating, it is possible to cool the engine 10. On the other hand, when the engine 10 is stopped, the fan 52 can be driven by driving the starter motor 60. According to an example embodiment, the fan 52, used to cool the engine 10, can be utilized as a fan to forcibly discharge hydrogen from the cowl 31 while the engine 10 is stopped.

According to an example embodiment, the hydrogen sensor 70 is located above the engine 10 when the outboard motor body 101 assumes an attitude where the drive shaft 21 extends in the vertical direction (see FIG. 2). Being a relatively light gas, hydrogen tends to accumulate in the upper portion of the inside of the cowl 31. According to an example embodiment, since the hydrogen sensor 70 is located at a relatively high position, the hydrogen sensor 70 is able to accurately detect the hydrogen concentration inside the cowl 31.

When the vessel 120 is docked, the outboard motor body 101 may be tilted forward as shown by a phantom line in FIG. 8. In this case, a portion of the cowl 31 that is located rearward of the middle position in the front-rear direction (see the straight line L1 in FIG. 8) moves upward as the outboard motor body 101 tilts. According to an example embodiment, the hydrogen sensor 70 is located rearward of the middle position between the front end and the rear end of the cowl 31 when the drive shaft 21 extends in the vertical direction. Therefore, when the outboard motor body 101 is tilted forward, the position of the hydrogen sensor 70 is kept at a relatively high position inside the cowl 31. Therefore, even when the outboard motor body 101 is tilted forward when docked, for example, it is possible to accurately detect the hydrogen concentration inside the cowl 31.

As described above, being a relatively light gas, hydrogen tends to accumulate in the upper portion of the inside of the cowl 31. According to an example embodiment, the exhaust port 45 of the cowl 31 is located above the engine 10 when the drive shaft 21 extends in the vertical direction. Thus, the exhaust port 45 is located at a relatively high position. Therefore, hydrogen inside the cowl 31 is able to be efficiently discharged through the exhaust port 45.

The engine 10 according to an example embodiment is a hydrogen engine that runs on hydrogen. Hydrogen may accumulate inside the crankcase 12, the cylinder body 13, the cylinder head 14, or the cylinder head cover 15 (that is, inside the engine) while the engine 10 is stopped. Hydrogen may accumulate inside the engine also while idling. The outboard motor 100 according to an example embodiment includes the gas passage 80 including the inlet 80a connected to the cylinder head cover 15 and the outlet 80b that opens toward the inside of the cowl 31, and the solenoid valve 81 provided in the gas passage 80 (see FIG. 10). By opening the solenoid valve 81, it is possible to discharge hydrogen inside the engine 10 to the inside of the cowl 31 through the gas passage 80. Hydrogen inside the cowl 31 is forcibly discharged by the fan 52 as described above. Therefore, according to an example embodiment, hydrogen inside the engine 10 can be forcibly discharged to the outside of the cowl 31.

According to an example embodiment, the controller 90 is configured or programmed to execute a control to close the solenoid valve 81 when the clutch 25 is engaged and the engine 10 is operating, and to open the solenoid valve 81 when the clutch 25 is disengaged or the engine 10 is stopped. By executing such controls, it is possible to discharge hydrogen inside the engine 10 to the outside of the engine 10 while the engine 10 is stopped or idling.

According to an example embodiment, the controller 90 is configured or programmed to execute a control to close the solenoid valve 81 when the rotational speed of the propeller shaft 23 is equal to or greater than a first speed, and to open the solenoid valve 81 when the rotational speed of the propeller shaft 23 is less than the first speed. By executing such controls, it is possible to discharge hydrogen inside the engine 10 to the outside of the engine 10 while operating at a very low speed when docked, for example.

According to an example embodiment, the controller 90 is configured or programmed to execute a control to open the solenoid valve 81 and drive the starter motor 60 for a predetermined period of time before the engine 10 is started or after the engine 10 is stopped. By executing such controls, it is possible to discharge hydrogen inside the engine 10 to the outside of the engine 10 before the engine 10 is started or after the engine 10 is stopped.

According to an example embodiment, the controller 90 is configured or programmed to execute a control to prevent starting the engine 10 when the hydrogen concentration detected by the hydrogen sensor 70 is equal to or greater than a predetermined second threshold. Therefore, it is possible to prevent the engine 10 from being started while the hydrogen concentration inside the cowl 31 is relatively high.

While example embodiments of an outboard motor have been described above, these example embodiments are merely examples. Various other example embodiments are possible. Next, examples of other example embodiments will be described.

In an example embodiment described above, the fan 52 to cool the engine 10 is used also as a fan to discharge hydrogen from the inside to the outside of the cowl 31 (hereinafter referred to as the hydrogen exhaust fan). In an example embodiment described above, the hydrogen exhaust fan is the fan 52 driven by the crank shaft 11 of the engine 10. However, the hydrogen exhaust fan may be a dedicated fan. An electric fan may be used as the hydrogen exhaust fan. The hydrogen exhaust fan may be provided at any location inside the cowl 31. For example, as shown in FIG. 12, an electric fan 66 may be provided inside the exhaust duct 48 as the hydrogen exhaust fan. Also in an example embodiment, by driving the electric fan 66, it is possible to discharge hydrogen inside the cowl 31 to the outside of the cowl 31 through the exhaust port 45. The electric fan 66 is electrically connected to the controller 90, and controlled by the controller 90. Also in an example embodiment, various controls similar to those of the example embodiments described above can be performed.

In an example embodiment described above, the exhaust duct 48 (see FIG. 5) is connected to the exhaust port 45 of the cowl 31, but the exhaust duct 48 may be optional. As long as gases can be smoothly discharged from the exhaust port 45, the outboard motor 100 may be provided without the exhaust duct 48.

The engine 10 is not limited to a multi-cylinder engine and may be a single-cylinder engine.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An outboard motor comprising:
a cowl including an exhaust port;
a hydrogen engine inside the cowl;
a drive shaft connected to the hydrogen engine and drivable by the hydrogen engine;
a propeller connected to the drive shaft;
a fan inside the cowl to discharge gases inside the cowl to outside of the cowl through the exhaust port;
a hydrogen sensor inside the cowl to detect a hydrogen concentration inside the cowl; and
a controller configured or programmed to drive the fan when the hydrogen concentration detected by the hydrogen sensor becomes equal to or greater than a first threshold while the hydrogen engine is stopped.

2. The outboard motor according to claim 1, wherein
the hydrogen engine includes a crank shaft;
the fan is connected to the crank shaft and rotatable by a driving force of the crank shaft;
the outboard motor includes a starter motor connected to the crank shaft to rotate the crank shaft; and
the controller is configured or programmed to drive the fan by driving the starter motor.

3. The outboard motor according to claim 1, wherein the fan is an electric fan.

4. The outboard motor according to claim 1, wherein the hydrogen sensor is located above the hydrogen engine when the drive shaft extends in a vertical direction.

5. The outboard motor according to claim 4, further comprising:
an outboard motor body including the cowl, the hydrogen engine, the drive shaft, the propeller, the fan, and the hydrogen sensor; and
a tilt shaft that supports the outboard motor body so that the outboard motor body is rotatable in a front-rear direction;
wherein the hydrogen sensor is located rearward of a middle position between a front end and a rear end of the cowl when the drive shaft extends in the vertical direction.

6. The outboard motor according to claim 1, wherein the exhaust port is located above the hydrogen engine when the drive shaft extends in a vertical direction.

7. The outboard motor according to claim 1, wherein
the hydrogen engine includes a crankcase supporting the crank shaft, a cylinder body connected to the crankcase, a cylinder head connected to the cylinder body, and a cylinder head cover connected to the cylinder head;
the outboard motor includes a gas passage including an inlet connected to the crankcase, the cylinder body, the cylinder head, or the cylinder head cover, and an outlet that opens toward an inside of the cowl; and
the outboard motor includes an electric valve in the gas passage.

8. The outboard motor according to claim 7, further comprising:
a propeller shaft connected to the propeller; and
a clutch connected to the drive shaft and the propeller shaft; wherein
the controller is electrically connected to the electric valve and configured or programmed to execute a control to close the electric valve when the clutch is engaged and the hydrogen engine is operating, and to open the electric valve when the clutch is disengaged or the hydrogen engine is stopped.

9. The outboard motor according to claim 7, further comprising:
a propeller shaft connected to the propeller; wherein
the controller is electrically connected to the electric valve and configured or programmed to execute a control to close the electric valve when a rotational speed of the propeller shaft is equal to or greater than a predetermined first speed, and to open the electric valve when the rotational speed of the propeller shaft is less than the first speed.

10. The outboard motor according to claim 7, further comprising:
a starter motor connected to the crank shaft and configured to rotate the crank shaft; wherein
the controller is configured or programmed to open the electric valve and drive the starter motor for a predetermined period of time before the hydrogen engine is started or after the hydrogen engine is stopped.

11. The outboard motor according to claim 1, wherein the controller is configured or programmed to prevent starting the hydrogen engine when the hydrogen concentration detected by the hydrogen sensor is equal to or greater than a predetermined second threshold.
